(19) United States
(12) Patent Application Publication
(10) Pub. No.: US 2025/0355443 A1
(43) Pub. Date: Nov. 20, 2025

(54) MANAGEMENT SYSTEM AND MANAGEMENT METHOD

(71) Applicant: TOYOTA JIDOSHA KABUSHIKI KAISHA, Toyota-shi (JP)

(72) Inventors: Satoshi TOYOSHIMA, Toyota-shi (JP); Shiro ODA, Anjo-shi (JP); Takeshi MATSUI, Nisshin-shi (JP)

(73) Assignee: TOYOTA JIDOSHA KABUSHIKI KAISHA, Toyota-shi (JP)

(21) Appl. No.: 19/023,438

(22) Filed: Jan. 16, 2025

(30) Foreign Application Priority Data
May 15, 2024 (JP) 2024-079707

(51) Int. Cl. G05D 1/644

(52) U.S. Cl. CPC G05D 1/644

(57) ABSTRACT

The management system according to the present embodiment is a management system that manages an autonomous mobile robot and a plurality of accessory units that are used in combination with the mobile robot to enable the mobile robot to execute a plurality of different services, and acquires combination information in which the accessory unit and the combination of the mobile robot are registered, and generates a control signal for executing the combination. The management system may use a machine learning model such as deep learning.

### CROSS-REFERENCE TO RELATED APPLICATION

This application claims priority to Japanese Patent Application No. 2024-079707 filed on May 15, 2024, incorporated herein by reference in its entirety.

### BACKGROUND

### 1. Technical Field

The present disclosure relates to a management system and a management method.

### 2. Description of Related Art

WO 2023/86665 discloses an autonomous mobile robot that tows a wheeled cart. The autonomous mobile robot includes a traction arm that tows the wheeled cart. The autonomous mobile robot tows the wheeled cart with the traction arm inserted under the wheeled cart.

### SUMMARY

In WO 2023/86665, the autonomous mobile robot can execute a transport service of transporting the wheeled cart. In such a mobile robot, there is a desire to execute a service other than the transport service.

An aspect of the present embodiment provides a management system that manages
an autonomous mobile robot, and
a plurality of accessory units that enables the autonomous mobile robot to execute a plurality of different services when used in combination with the autonomous mobile robot, in which:
the management system acquires combination information in which combinations of the accessory units and the mobile robot are registered; and
the management system generates a control signal for executing the combinations.

An aspect of the present embodiment provides a management method of managing
an autonomous mobile robot, and
a plurality of accessory units that enables the autonomous mobile robot to execute a plurality of different services when used in combination with the autonomous mobile robot, the management method including:
acquiring combination information in which combinations of the accessory units and the mobile robot are registered; and
generating a control signal for executing the combinations.

According to the present disclosure, it is possible to provide a management system and a management method capable of appropriately combining an autonomous mobile robot and accessory units according to services.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an overall configuration of a management system according to the present embodiment;

FIG. 2 is a block diagram illustrating a control system of the management system;

FIG. 3 is a side view schematically showing a configuration before and after the cleaning unit is connected; and

FIG. 4 is a flowchart illustrating a management method.

### DETAILED DESCRIPTION OF EMBODIMENTS

Hereinafter, the present disclosure will be described through embodiments of the disclosure. However, the disclosure according to the claims is not limited to the following embodiments. Moreover, all of the configurations described in the embodiments are not necessarily indispensable as means for solving the issue.

### Overall Configuration

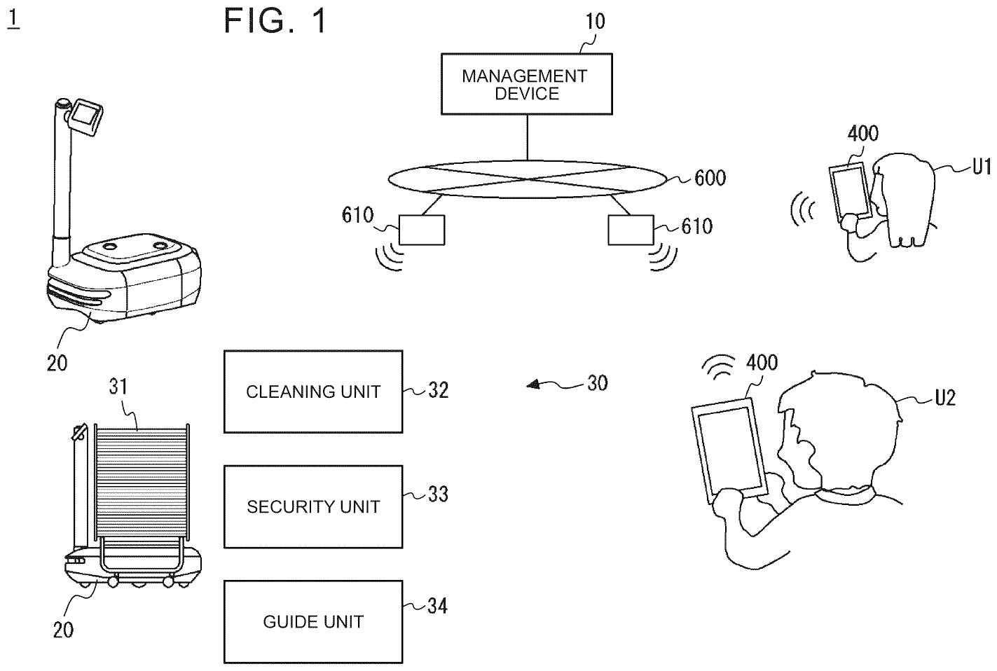

The management system according to the present embodiment is a system for managing an autonomous mobile robot capable of executing a plurality of services (also referred to as tasks). FIG. 1 is a schematic diagram illustrating a configuration of a management system 1. The management system 1 includes a mobile robot 20, a host management device 10, an accessory unit 30, a network 600, a communication unit 610, and a user terminal 400. The management system 1 is a system for managing one or a plurality of mobile robots 20 and an accessory unit 30 thereof.

The accessory unit 30 is used in combination with the mobile robot 20 to execute each service. For example, the accessory unit 30 is a conveyance unit 31, a cleaning unit 32, a security unit 33, and a guide unit 34. Of course, the accessory unit 30 is not limited to these units, and may include units for other services. The accessory unit 30 may be devoid of one or more of the above four.

The mobile robot 20 is an autonomous mobile robot and executes a plurality of services such as transportation, cleaning, security, and guidance. The mobile robot 20 autonomously moves medical welfare facilities such as hospitals, rehabilitation centers, nursing facilities, and residential facilities for the elderly. Moreover, the system according to the present embodiment can also be used in commercial facilities such as shopping malls. The mobile robot includes wheels, a chassis, a motor, a sensor, a battery, a controller, and the like.

The mobile robot 20 mounts any one of the conveyance unit 31, the cleaning unit 32, the security unit 33, and the guide unit 34 in accordance with a service to be executed. For example, the mobile robot 20 mounts the conveyance unit 31 when the transport service is executed. When executing a cleaning service, a security service, or a guidance service, the mobile robot 20 is equipped with a cleaning unit 32, a security unit 33, or a guide unit 34, respectively. As described above, the accessory unit 30 is prepared in advance for each service to be executed.

The mobile robot 20 selectively attaches any one of the conveyance unit 31, the cleaning unit 32, the security unit 33, and the guide unit 34. That is, the mobile robot 20 selectively uses the accessory unit 30 according to the service to be executed. Of course, the mobile robot 20 may be capable of mounting two or more accessory units 30 at the same time. Further, the mobile robot 20 may be configured to be able to attach the accessory unit 30 only by its own operation, but may be configured to be assisted by a user or the like.

The conveyance unit 31 is an accessory unit 30 for transporting a conveyed object. For example, the conveyance unit 31 is a wagon or a cart with wheels, and is capable of mounting a conveyed object therein. The carriage portion of the mobile robot 20 serves as a stage on which a wagon or the like is mounted. The mobile robot 20 has an elevating function for lifting the conveyance unit 31. When the carriage portion of the mobile robot 20 enters the lower side of the conveyance unit 31, an elevating stage or the like lifts the conveyance unit 31. As a result, the mobile robot 20 mounts the conveyance unit 31. The mobile robot 20 can convey the conveyed object stored in the conveyance unit 31 to the destination. The mobile robot 20 can execute the conveyance service by mounting the conveyance unit 31. The conveyance unit 31 is used for serving a table in a restaurant, a medical welfare facility, or the like, and for a lower table. The conveyance unit may be used for transporting parts in a factory, transporting samples in a hospital, transporting linen in a hotel, and the like.

The cleaning unit 32 is an accessory unit 30 for cleaning a facility. The cleaning unit 32 includes a cleaner that sucks dust and the like. Alternatively, the cleaning unit 32 includes a pad, a mop, or the like for wiping the floor. When the mobile robot 20 moves with the cleaning unit 32 mounted thereon, the floor surface is cleaned. That is, in the region where the mobile robot 20 has moved, the floor surface is cleaned. The mobile robot 20 can execute the cleaning service by mounting the cleaning unit 32. The cleaning unit 32 may also be a remotely controllable robotic cleaner. In this case, the mobile robot 20 performs the cleaning service by remotely controlling the cleaning unit 32 by wireless communication.

The security unit 33 is an accessory unit 30 for securing the facility. The security unit 33 includes, for example, various sensors for detecting intruders and abnormalities. For example, the security unit 33 includes a camera, an infrared camera, a ranging sensor, an optical sensor, a thermal sensor, and a smoke sensor as sensors. A lighting device for illuminating an intruder or an abnormal portion may be provided. The accessory unit 30 may have an alarm function or the like for notifying when an abnormality is detected. The mobile robot 20 can execute the security service by wearing the security unit 33.

The guide unit 34 is an accessory unit 30 for guiding the facility. For example, the guide unit 34 guides the visitor of the facility a route to the destination or the like. The guide unit 34 has an input device for a visitor to input a destination. The input device includes a touch panel and buttons. The input device also includes a microphone for voice input. The mobile robot 20 moves to a destination in order to guide a visitor. The guide unit 34 may include a display device for displaying a route and a speaker for outputting a voice of the route.

As described above, the accessory unit 30 is used in combination with the mobile robot 20, so that the mobile robot 20 can execute a plurality of different services. That is, the mobile robot 20 executes a service corresponding to the accessory unit 30. In addition, an available accessory unit 30 and an unavailable accessory unit 30 may be set according to the mobile robot 20. That is, whether or not the combination of the mobile robot 20 and the accessory unit 30 can be set in advance.

A plurality of accessory units 30 for one service may be provided. In the management system 1, for example, two or more conveyance units 31 may be provided. In this case, the two mobile robots 20 can simultaneously execute the transport service using the conveyance unit 31. Further, a plurality of types of accessory units 30 may be prepared for one service. For example, the shape and size of the conveyance unit 31 may be different depending on the contents of the conveyed material.

The user U1 or the user U2 can use the user terminal 400 to make a service request such as a conveyance request for a conveyed object. For example, the user terminal 400 is a tablet computer, smart phone, or the like. The user terminal 400 only needs to be an information processing device capable of wireless or wired communication.

In the present embodiment, the mobile robot 20 and the user terminals 400 are connected to the host management device 10 via the network 600. The mobile robot 20 and the user terminals 400 are connected to the network 600 via the communication units 610. The network 600 is a wired or wireless local area network (LAN) or wide area network (WAN). The host management device 10 is connected to the network 600 by wire or wirelessly. The communication unit 610 is, for example, a wireless LAN unit installed in each environment. The communication unit 610 may be, for example, a general purpose communication device such as a Wi-Fi router.

Various signals transmitted from the user terminals 400 of the users U1 and U2 are once sent to the host management device 10 via the network 600, and transmitted from the host management device 10 to the target mobile robot 20. Similarly, various signals transmitted from the mobile robot 20 are once sent to the host management device 10 via the network 600, and transmitted from the host management device 10 to the target user terminal 400. The host management device 10 is a server connected to each equipment, and collects data from each equipment. The host management device 10 is not limited to a physically single device, and may have a plurality of devices that performs distributed processing. Further, the host management device 10 may be distributedly provided in an edge device such as the mobile robot 20. For example, a part or all of the management system 1 may be mounted on the mobile robot 20.

The user terminal 400 and the mobile robot 20 may transmit and receive signals without the host management device 10. For example, the user terminal 400 and the mobile robot 20 may directly transmit and receive signals by wireless communication. Alternatively, the user terminal 400 and the mobile robot 20 may transmit and receive signals via the communication unit 610.

It is assumed that a plurality of mobile robots 20 are used in a facility. The host management device 10 assigns a service to each mobile robot 20. Each of the mobile robots 20 is equipped with an accessory unit 30 corresponding to the assigned service, and executes the service. The service executed by the mobile robot 20 may be entered by a user U1 or a user U2, or may be scheduled in advance. For example, a user U1 or the like operates the user terminal 400 to make a service request. A user U1 or the like can enter the type of service to be executed. A user U1 or the like may enter an area, a time-zone, or the like in which the service is executed.

In such an overall configuration, each element of the management system 1 can be distributed among the mobile robot 20, the user terminal 400, and the host management device 10 to construct the management system 1 as a whole. Further, it is possible to collect substantial elements for achieving the transportation of the transported object in a single device to construct the system. The host management device 10 controls one or more mobile robots 20.

### Control System

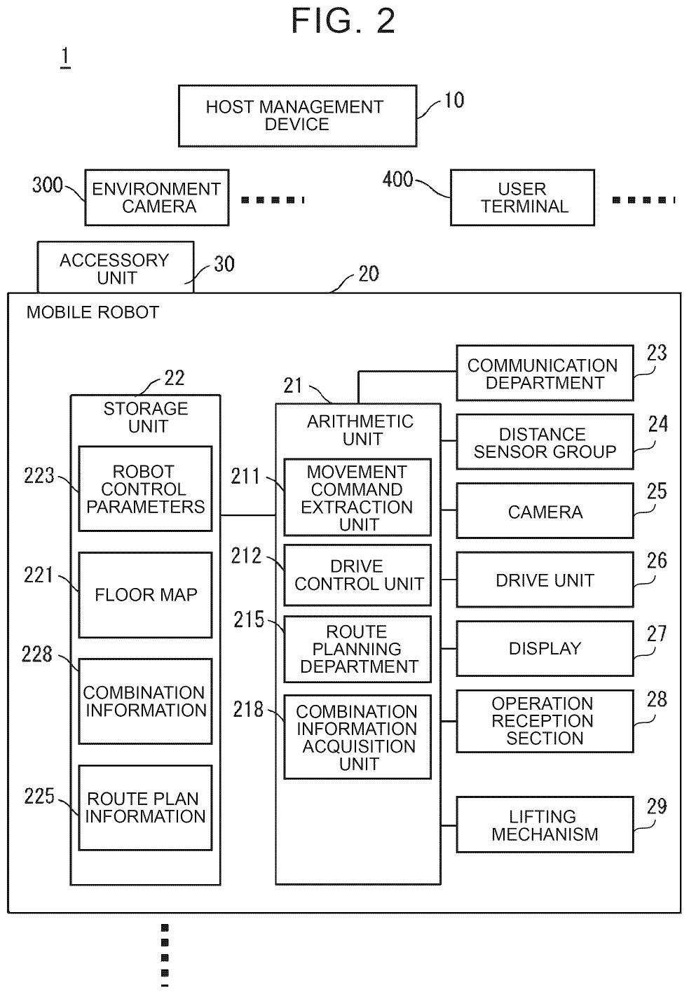

FIG. 2 is a block diagram illustrating a control system of the management system 1 according to the present embodiment. As illustrated in FIG. 2, the management system 1 includes a host management device 10, a mobile robot 20, an accessory unit 30, an environment camera 300, and a user terminal 400. In FIG. 2, the network 600 and the communication unit 610 are omitted. Although only one mobile robot 20 is illustrated in FIG. 2, a plurality of mobile robots 20 may be used.

The host management device 10 includes a personal computer or the like, and performs an operation for controlling and managing the mobile robot 20. The host management device 10 can be implemented as, for example, a device capable of executing a program such as a central processing unit (CPU: Central Processing Unit) of a computer. Various functions can also be realized by the program. For example, the host management device 10 manages the mobile robot 20 so as to operate efficiently. For example, upon receiving a service request from the user terminal 400 or the like, the host management device 10 selects one mobile robot 20 from the plurality of mobile robots 20 and instructs the mobile robot 20 to execute the service.

A plurality of environment cameras 300 are installed in a facility where the mobile robot 20 travels. For example, the environment cameras 300 are each installed in a passage, a hallway, an elevator, an entrance, etc. in the facility.

The environment cameras 300 acquire images of ranges in which the mobile robot 20 moves. In the management system 1, the image acquired by the environment camera 300 and information based on the image are collected by the host management device 10. Alternatively, an image or the like acquired by the environment camera 300 may be directly transmitted to the mobile robot 20. The environment cameras 300 may be surveillance cameras or the like provided in a passage or an entrance/exit in the facility.

In the management system 1, the mobile robot 20 performs route planning based on the service information. Based on the route plan information created by the mobile robot 20, the mobile robot autonomously moves toward the destination. The mobile robot 20 autonomously moves toward the destination using sensors, floor maps, position information, and the like provided in the mobile robot 20 itself. Of course, a part of the processing of the mobile robot 20 may be performed by the host management device 10.

For example, the mobile robot 20 travels so as not to come into contact with surrounding equipment, objects, walls, and people (hereinafter collectively referred to as peripheral objects). Specifically, the mobile robot 20 detects a distance to a surrounding object and travels in a state of being separated from the surrounding object by a certain distance (also referred to as a distance threshold or a margin distance) or more. When the distance from the peripheral object becomes equal to or less than the distance threshold value, the mobile robot 20 decelerates or stops. With this configuration, the mobile robot 20 can travel without coming into contact with the peripheral objects. Since contact can be avoided, safe and efficient transportation is possible.

The mobile robot 20 includes an arithmetic processing unit 21, a storage unit 22, a communication unit 23, a distance sensor group 24, a camera 25, a drive unit 26, a display unit 27, and an operation reception unit 28. Although FIG. 2 shows only typical processing blocks provided in the mobile robot 20, the mobile robot 20 also includes many other processing blocks that are not shown.

The communication unit 23 is a communication interface for communicating with the host management device 10, the environment camera 300, or another mobile robot 20. The communication unit 23 communicates with the host management device 10 or the like using, for example, a wireless signal. The distance sensor group 24 is, for example, a proximity sensor, and outputs proximity object distance information indicating a distance from an object or a person that is present around the mobile robot 20. The camera 25, for example, captures an image for grasping the surrounding situation of the mobile robot 20. The mobile robot 20 may identify a surrounding object based on an image of the camera 25 or the environment camera 300.

The drive unit 26 includes a motor that drives drive wheels provided in the mobile robot 20. Note that, the drive unit 26 may include an encoder or the like that detects the number of rotations of the drive wheels and the drive motor thereof. The position of the mobile robot 20 (current position) may be estimated based on the output of the above encoder. The mobile robot 20 detects its current position and transmits the information to the host management device 10.

The display unit 27 and the operation reception unit 28 are realized by a touch panel display. The display unit 27 displays a user interface screen that serves as the operation reception unit 28. Further, the display unit 27 may display information indicating the destination of the mobile robot 20 and the state of the mobile robot 20. The operation reception unit 28 receives an operation from the user. The operation reception unit 28 includes various switches provided on the mobile robot 20 in addition to the user interface screen displayed on the display unit 27.

The lifting mechanism 29 lifts and lowers a carriage unit for mounting the conveyance unit 31. The lifting mechanism 29 includes a motor and a lifting stage that is moved up and down by the motor. The elevating stage is provided in a carriage portion of the mobile robot 20. In a state in which the stage is directly below the conveyance unit 31, the lifting mechanism 29 raises the stage, and thus the conveyance unit 31 is raised. Since the wheels of the conveyance unit 31 are separated from each other, the conveyance unit 31 is stacked on the mobile robot 20 (see FIG. 1). When the mobile robot 20 transports the conveyed object to the destination, the lifting mechanism 29 lowers the stage. As a result, the conveyance unit 31 is lowered from the stage.

The storage unit 22 stores a floor map 221, robot control parameters 223, and combination information 228. The information illustrated in FIG. 2 is a part of the information stored in the storage unit 22, and may include information other than the floor map 221, the robot control parameter 223, and the combination information 228 illustrated in FIG. 2.

The floor map 221 is map information of a facility in which the mobile robot 20 moves. The floor map 221 may be downloaded from the host management device 10, for example. The floor map 221 may be created in advance. Further, the floor map 221 may not be the map information of the entire facility but may be the map information including part of the area in which the mobile robot 20 is scheduled to move.

The route plan information 225 includes route plan information planned by the route planning unit 215. The route plan information 225 includes, for example, information indicating a destination and route information to the destination. The route plan information 225 may include information such as a departure point, a scheduled start time of a service, and a scheduled end time. The route plan information may include information on a passing point or a passing place in the moving route. In the route plan information 225, the above-described various types of information may be associated with each service. The route plan information 225 may include at least a part of the service information or the like inputted from the user U1.

The combination information 228 includes information about a combination of the mobile robot 20 and the accessory unit 30. Therefore, the mobile robot 20 and the accessory unit 30 are registered in the combination information 228. A plurality of combinations is registered in the combination information 228. One combination of the combination information 228 is information associating one mobile robot 20 with one accessory unit 30. Further, the combination information 228 may include information on whether or not the combination of the mobile robot 20 and the accessory unit 30 is possible. The combination information may include information for the mobile robot 20 to use the accessory unit 30. The combination information may include location information in which the accessory unit 30 is stored.

The combination information 228 may include information indicating how the mobile robot 20 connects the accessory unit 30. Here, as a connection method between the mobile robot 20 and the accessory unit 30, there are three types of connection: a connection by an elevating operation, a connection by a connecting operation, and a connection by a wireless signal.

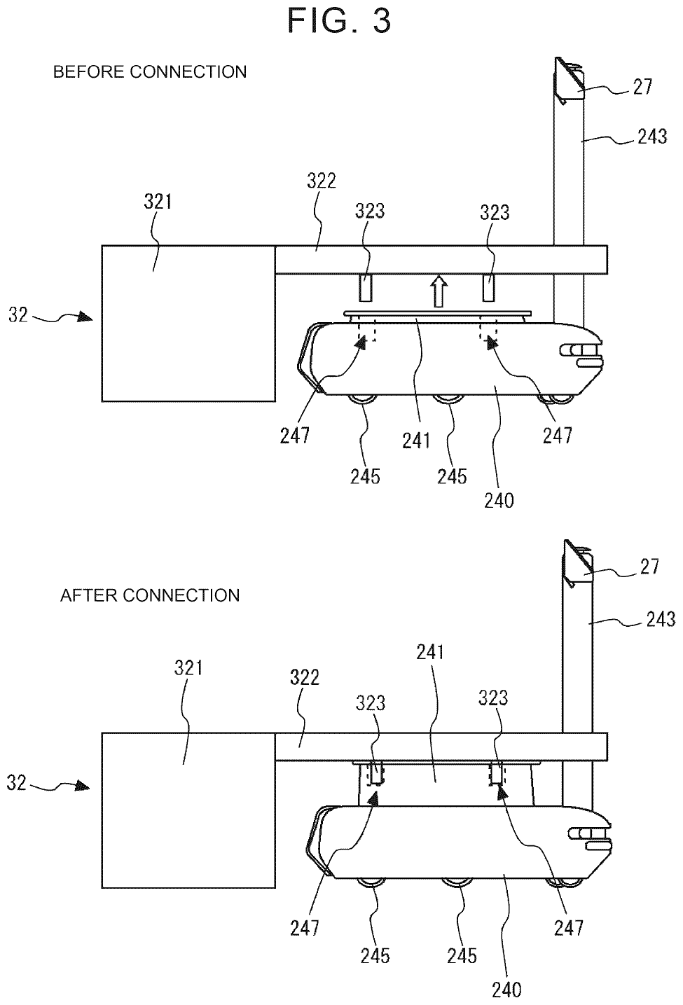

In the connection by the lifting operation, the mobile robot 20 operates the lifting mechanism to mount the accessory unit 30. Specifically, when the mobile robot 20 raises the elevating stage by the lifting mechanism 29 in a state where the elevating stage is directly below the conveyance unit 31, the conveyance unit 31 is mounted on the mobile robot 20 as shown in FIG. 1. Further, as shown in FIG. 3, the cleaning unit 32 may be connected to the mobile robot 20 by an elevating operation. FIG. 3 is a side view schematically showing a configuration before and after connection of the cleaning unit 32.

The cleaning unit 32 includes a cleaner 321, a support portion 322, and a fixing pin 323. The cleaner 321 is coupled to the support portion 322. Further, a fixing pin 323 is provided on the lower side of the support portion 322. The fixing pin 323 is a convex portion protruding to the lower side of the support portion 322.

The mobile robot 20 includes a chassis 240, an elevating stage 241, a support 243, wheels 245, and a display unit 27. The chassis 240 is provided with wheels 245. The wheel 245 rotates about an axle provided on the chassis 240. An elevating stage 241 is provided on the chassis 240. A recess 247 into which the fixing pin 323 is inserted is provided on the upper surface of the elevating stage 241. The recess 247 is provided at a position corresponding to the fixing pin 323. A support 243 is provided at an end portion of the chassis 240. The support 243 extends upward from the chassis 240. A touch panel display serving as a display unit 27 or the like is installed on the support 243.

The mobile robot 20 moves and moves to the lower side of the support portion 322. That is, the mobile robot 20 moves so that the chassis 240 is directly under the support portion 322. Then, when the elevating stage 241 provided in the chassis 240 is raised, the fixing pin 323 is inserted into the recess 247. Thus, the cleaning unit 32 is connected to the mobile robot 20. When the mobile robot 20 travels to push or pull the cleaning unit 32, a cleaning service is performed. The conveyance unit 31 shown in FIG. 1 may also be mounted on the mobile robot 20 with a configuration similar to that of the cleaning unit 32.

In the connection by the coupling operation, for example, a coupling mechanism for coupling to one or both of the mobile robot 20 and the accessory unit 30 is provided. When the mobile robot 20 travels, the mobile robot 20 and the accessory unit 30 are connected to each other. The coupling mechanism includes, for example, a hook mechanism, a locking mechanism, an engagement mechanism, a projection, a pin, a traction arm, a hole, a guide mechanism, a joint mechanism, or the like. As the mobile robot 20 approaches the accessory unit 30, a locking piece, a hook, or the like of the mobile robot is coupled to the accessory unit 30. When the mobile robot 20 travels forward or backward, the mobile robot 20 and the accessory unit 30 are coupled to each other. As a result, the accessory unit 30 is attached to the mobile robot 20. Alternatively, a configuration may be adopted in which a user or the like assists in the connection operation.

In the connection by the wireless signal, the mobile robot 20 transmits the wireless signal to the accessory unit 30. For example, the mobile robot 20 and the accessory unit 30 are paired with each other by Bluetooth (registered trademark) or the like. Then, the mobile robot 20 transmits a wireless signal for remotely controlling the accessory unit 30. In this case, for example, the accessory unit 30 is a cleaning unit including a cleaning robot.

Furthermore, in the combination information 228, information on the connection method is registered for each mobile robot 20 or for each accessory unit 30. Alternatively, in the combination information 228, information on the connection method and the connection operation may be registered for each combination. The combination information 228 may include control parameters, setting values, and the like for performing a connection operation to the accessory unit 30.

For example, in the connection by the connection operation, the combination information 228 includes information on the relative position information, the approaching direction, the approaching distance, and the moving speed at the time of approaching of the mobile robot 20 with respect to the accessory unit 30. The connection by the elevating operation may include information such as a relative position, an approaching direction, an elevating amount, and an elevating speed of the mobile robot 20 with respect to the accessory unit 30. In a wireless connection, the combination information 228 may include information such as a frequency band and a channel of a wireless signal.

The robot control parameter 223 is a parameter used for controlling the operation of the mobile robot 20. The robot control parameters 223 include a threshold distance or the like between the mobile robot 20 and the surrounding object. The threshold distance is a margin distance (also referred to as a virtual bumper distance) for avoiding contact with a surrounding object including a person. Further, the robot control parameter 223 may include speed information related to a speed such as a speed upper limit value of the mobile robot 20. The robot control parameters 223 may include at least one of speed information, height of the lifting mechanism, virtual bumper distance, suspension hardness, turning radius, allowable inclination angle, travelable environment designation, battery consumption mode, and wireless sensitivity.

The arithmetic processing unit 21 performs arithmetic used for controlling the mobile robot 20. The arithmetic processing unit 21 can be implemented as a device capable of executing a program such as a central processing unit (CPU) of a computer, for example. Various functions can also be realized by the program. The arithmetic processing unit 21 includes a movement command extraction unit 211, a drive control unit 212, a parameter acquisition unit 213, a route planning unit 215, and a combination information acquisition unit 218. Although FIG. 2 shows only typical processing blocks included in the arithmetic processing unit 21, the arithmetic processing unit 21 includes processing blocks that are not shown.

The movement command extraction unit 211 extracts a movement command from the control signal and the route plan information 225 given from the host management device 10. For example, the movement command includes information on the next passing point. For example, the control signal may include information on the coordinates of the passing points and the passing order of the passing points. The movement command extraction unit 211 extracts these types of information as a movement command.

The drive control unit 212 controls the drive unit 26 such that the drive unit 26 moves the mobile robot 20 based on the movement command given from the movement command extraction unit 211. For example, the drive unit 26 includes drive wheels that rotate in accordance with a control command value from the drive control unit 212. The movement command extraction unit 211 extracts a movement command so that the mobile robot 20 moves along the movement path indicated by the route plan information 225. The drive unit 26 rotationally drives the drive wheels. The mobile robot 20 autonomously moves toward a destination or a waypoint. The mobile robot 20 may estimate its own position and transmit a signal indicating that it has passed through a waypoint or the like to the host management device 10. Thus, the host management device 10 can manage the current position and the transportation status of each mobile robot 20.

The route planning unit 215 performs route planning of the mobile robot 20. Upon receiving the service request from the user terminal 400 or the host management device 10, the route planning unit 215 performs a route plan for executing the service based on the service information. For example, the route planning unit 215 searches for a route to the area where the service is to be performed or a route in the service. As a result, a movement path in the floor map 221 is obtained. The route plan calculated by the route planning unit 215 is written in the storage unit 22 as route plan information 225.

Specifically, the route planning unit 215 refers to the floor map 221, the combination information 228, and the like that are already stored in the storage unit 22, and sets a departure point, a passing point, and a destination. The departure point is a current position or the like. The transit place is the detachment position of the accessory unit 30, etc. The destination is, for example, a place where the service is executed. Further, in a case where an area for executing a cleaning service, a monitoring service, or the like is set, the route planning unit 215 performs route planning using a point in the area where the service is performed as a via point or a destination.

When a service to be executed is assigned to the mobile robot 20 from the host management device 10, the user terminal 400, or the like, the combination information acquisition unit 218 identifies the accessory unit 30 to be used. When there is a plurality of accessory units 30 used for the service to be executed, the host management device 10 or the mobile robot 20 selects one accessory unit 30 from the plurality of accessory units 30. The combination information acquisition unit 218 acquires the combination information 228 in which the combination of the mobile robot 20 and the accessory unit 30 is registered. The combination information acquisition unit 218 may acquire the combination information based on the detection results of the camera 25 and the distance sensor group 24. The arithmetic processing unit 21 generates a control signal for executing the combination.

The mobile robot 20 refers to the combination information 228 corresponding to the accessory unit 30, and executes an operation for connecting the accessory unit 30. The arithmetic processing unit 21 refers to the combination information 228 and generates a control signal for executing the combination. The combination information 228 may include location information of the accessory unit 30 in the floor map 221 and an identification number of the accessory unit 30. The combination information acquisition unit 218 acquires information on the accessory unit 30 to be used from the host management device 10. Alternatively, the combination information acquisition unit 218 may acquire the identification number or the like of the accessory unit 30 by specifying the accessory unit 30 in the vicinity of the mobile robot 20 based on an image or the like of the camera 25. Based on the control signal, the mobile robot 20 moves to the position of the accessory unit 30 and connects to the accessory unit 30.

For example, the combination information may include information indicating a method of connecting the accessory unit 30 to the mobile robot 20. The combination information 228 includes information indicating whether the mobile robot connects or remotely controls the accessory unit. Further, the combination information 228 includes information indicating whether the connection with the mobile robot 20 is a connection by an elevating operation or a connection by a connection operation. By referring to the combination information, the combination information acquisition unit 218 can specify whether the connection between the mobile robot 20 and the accessory unit 30 is a connection by an elevating operation, a connection by a connecting operation, or a connection by a wireless connection. Then, the arithmetic processing unit 21 generates a control signal by referring to the combination information. As a result, the mobile robot 20 can appropriately execute the combination corresponding to the service.

The mobile robot 20 includes information related to a connection operation for connecting to the accessory unit 30. For example, the combination information 228 includes information on the approach direction, the approach distance, the relative position of the mobile robot 20 with respect to the accessory unit 30, and the elevation height. Then, the arithmetic processing unit 21 refers to the combination information 228 to generate a control signal. As a result, the mobile robot 20 can appropriately execute the combination corresponding to the accessory unit 30.

The relative position of the mobile robot 20 with respect to the accessory unit 30 can be measured from the detection result of the distance sensor group 24. Alternatively, the arithmetic processing unit 21 can measure a relative position from an image of the camera 25 or the environment camera 300. That is, the position of the mobile robot 20 with respect to the accessory unit 30 may be adjusted based on the detection result of the distance sensor group 24 and the camera image. In this case, the mobile robot 20 can approach accurately along the approach distance, the approach direction, and the like indicated by the combination information. Therefore, the mobile robot 20 can appropriately perform the combination operation and the connection operation of the accessory unit 30.

The combination information includes information indicating whether the mobile robot 20 connects or remotely controls the accessory unit 30. When remote control is performed, the mobile robot 20 moves to the vicinity of the accessory unit 30. That is, the mobile robot 20 moves to a range in which wireless communication is possible with respect to the accessory unit 30, and is paired with the accessory unit 30. The mobile robot 20 remotely controls the accessory unit 30 by a wireless signal. When the mobile robot 20 is wirelessly connected to the accessory unit 30, the arithmetic processing unit 21 generates a control signal so that the mobile robot 20 performs a predetermined wireless connection operation to the accessory unit 30. In this way, the mobile robot 20 and the accessory unit 30 can execute an appropriate combination.

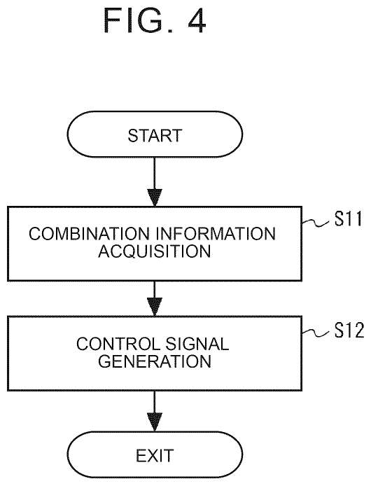

FIG. 4 is a flowchart illustrating a management method. The management method manages the mobile robot 20 and a plurality of accessory units that are used in combination with the mobile robot 20 to enable the mobile robot to execute a plurality of different services.

The combination information acquisition unit 218 acquires combination information of the mobile robot 20 and the accessory unit 30 (S11). The drive control unit 212 or the movement command extraction unit 211 generates a control signal for executing the combination by referring to the combination information (S12). Accordingly, the mobile robot 20 can execute an operation for performing combination with the accessory unit 30 based on the control signal. In this way, it is possible to appropriately combine the autonomous mobile robot and the accessory unit according to the service. In a case where the mobile robot 20 is used by selecting one accessory unit 30 from among the plurality of accessory units 30, the management system 1 can appropriately perform a combination with the accessory unit 30. Of course, at least a part of the processing of the mobile robot 20 may be performed by the host management device 10.

Further, the robot control parameters 223 may be adjustable by a user or an administrator. For example, when the user or the like selects the adjustment of the robot control parameter 223, the user terminal 400 displays a bar or the like for the adjustment. The control parameters are updated by the user or the like operating the user terminal 400. The robot control parameters 223 may be updated for each service. When the parameter acquisition unit 213 acquires the updated value, the value of the robot control parameter 223 in the storage unit 22 is rewritten. Then, the arithmetic processing unit 21 controls the operation of the mobile robot by using the updated robot control parameters. In this way, the mobile robot 20 controls the operation using more appropriate robot control parameters 223. When the mobile robot executes the same service again, the mobile robot 20 performs control using the updated robot control parameter 223.

The mobile robot 20 may use a machine learning model such as deep learning in the control of the route planning and the drive control unit 212. Further, in detection of a surrounding object or the like, a machine learning model such as deep learning such as RNN (Recurrent Neural Network) or CNN (Convolutional neural network) may be used.

In addition, some or all of the processing in the mobile robot 20, the host management device 10, and the like described above can be realized as a computer program. The program as described above is stored using various types of non-transitory computer-readable media, and can be supplied to a computer. The non-transitory computer-readable media include various types of tangible recording media. Examples of the non-transitory computer-readable media include magnetic recording media (e.g. flexible disks, magnetic tapes, hard disk drives), magneto-optical recording media (e.g. magneto-optical disks), compact disc read-only memory (CD-ROM), compact disc recordable (CD-R), compact disc rewritable (CD-R/W), and semiconductor memory (e.g. mask ROM, programmable ROM (PROM), erasable PROM (EPROM), flash ROM, random access memory (RAM)). Further, the program may also be supplied to the computer by various types of transitory computer-readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

The present disclosure is not limited to the above embodiment, and can be appropriately modified without departing from the spirit.

What is claimed is:

1. A management system that manages an autonomous mobile robot, and a plurality of accessory units that enables the autonomous mobile robot to execute a plurality of different services when used in combination with the autonomous mobile robot, wherein:
the management system acquires combination information in which combinations of the accessory units and the autonomous mobile robot are registered; and
the management system generates a control signal for executing the combinations.

2. The management system according to claim 1, wherein the combination information includes information indicating a method of connecting the accessory units to the autonomous mobile robot.

3. The management system according to claim 2, wherein the combination information includes information about connection operation for the autonomous mobile robot to connect to the accessory units.

4. The management system according to claim 1, wherein the combination information includes information indicating whether the autonomous mobile robot connects to or remotely controls the accessory units.

5. A management method of managing an autonomous mobile robot, and a plurality of accessory units that enables the autonomous mobile robot to execute a plurality of different services when used in combination with the autonomous mobile robot, the management method comprising:
acquiring combination information in which combinations of the accessory units and the autonomous mobile robot are registered; and
generating a control signal for executing the combinations.
